(19) United States
(12) Patent Application Publication
(10) Pub. No.: US 2009/0022557 A1
(43) Pub. Date: Jan. 22, 2009

(54) AUTOMATED CHUCK EXCHANGE USING ROTATING TURRET

(75) Inventor: John Whitehead, Victoria (AU)

Correspondence Address: HANLEY, FLIGHT & ZIMMERMAN, LLC, 150 S. WACKER DRIVE, SUITE 2100, CHICAGO, IL, 60606, US

(73) Assignee: Whitehot Solutions Pty Ltd, Mitcham (AU)

(21) Appl. No.: 11/911,170

(22) PCT Filed: Apr. 11, 2006
(86) PCT No.: PCT/AU2006/000483

§ 371 Date: Oct. 10, 2007

(30) Foreign Application Priority Data
Apr. 11, 2005 (AU) 2005901765

(51) Int. Cl. B23B 39/20

(52) U.S. Cl. 408/35

(57) ABSTRACT

A tool including a drive shaft having an axis of rotation and a plurality of bit holders interchangeable with one another at a position of use. The bit holders are mounted at arcuately-spaced positions on a turret rotatable around an axis that is set at an angle to the axis of rotation of the drive shaft. The drive shaft is reciprocal between first and second axially-spaced locations at which, respectively, the drive shaft is engaged and disengaged from the bit holder at the position of use. The positioning of the drive shaft at the second location establishes a drive connection between the drive shaft and the turret so that subsequent operation of the drive shaft rotates the turret to interchange the positions of the bit holders at the position of use. The drive shaft is adapted to return to the first location and restore the drive connection with a new bit holder at the position of use after the turret has been rotated.

### RELATED APPLICATION

This patent is the National Stage of International Patent Application Ser. No. PCT/AU2006/000483, filed Apr. 11, 2006, which claims priority to Australian Patent Application 2005901765, filed on Apr. 11, 2005, both of which are hereby incorporated herein by reference in their entireties.

### FIELD OF THE DISCLOSURE

The disclosure relates, generally, to a tool having one drive shaft and rotatable bit holders that can be selectively brought to a position of use in front of the tool to enable the drive shaft to be connected to one of the bit holders in this position, and more specifically, to an automated chuck exchange using a rotating turret.

### BACKGROUND

Any discussion of documents, devices, acts or knowledge in this specification is included to explain the context of the illustrated examples. It should not be taken as an admission that any of the material forms a part of the prior art base or the common general knowledge in the relevant art in Australia or elsewhere on or before the priority date of the disclosure and claims herein.

International Patent Application No. PCT/US2000/009080 (WO 2001/017728) by Richard D. Cummins, describes a hand drill having a drive shaft and a turret that is manually rotatable about an axis set at 45° to the rotational axis of the drive shaft. The turret has two chucks arranged at 90° to one another and arcuately spaced around the axis of rotation of the turret. A user of the drill can load each of the chucks with an appropriately-sized drill bit so that each drill bit can be used in turn to conduct a particular operation requiring the use of two bits. To interchange the drill bits the user must hold the pistol grip of the drill in one hand and, after disengaging the drill shaft from a first chuck currently at a position of use, manually turn the turret through an angle of 180°. This action brings a second chuck, and corresponding drill bit, to the position of use, wherein tile user can then selectively re-engage the drive shaft with this second chuck to facilitate use of the drill bit.

### BRIEF DESCRIPTION OF THE DRAWINGS

The illustrated examples may be more clearly understood and put into practical effect by the following detailed descriptions of an example hand-held drill. The ensuing description is given by way of non-limitative examples only and is with reference to the accompanying drawings, wherein:

FIGS. 1a & 1b illustrate cross-sectional side views of an example hand-held electric drill, having an example pistol grip;

FIGS. 2a & 2b are cross-sectional plan views of FIGS. 1a & 1b respectively;

FIG. 3 is a cross-sectional plan view of the example hand-held electric drill of FIGS. 1a to 2b, showing an example turret of the drill rotated approximately half-way between the position of use of both the example chucks of the drill;

FIG. 4 is a partial side view of the drill of FIG. 3;

FIGS. 5a to 5f are enlarged partial cross-sectional views of example internal components of the example hand-held electric drill of FIGS. 1a to 4, the example components facilitating the rotation of the example turret and the engaging and disengaging of the drive shaft with the respective chucks, each drawing showing a different phase of operation of the drill;

FIG. 6 is a cross-sectional side view of an example hand-held electric drill, having an example pistol grip; and

FIGS. 7a to 7d are cross-sectional side views of the example hand-held electric drill of FIG. 6, each showing a different phase of operation of the drill.

### DETAILED DESCRIPTION

There are many situations that a user of a drill does not have both hands free. If both hands are not free, a user cannot interchange the chucks, and hence the drill bits, without taking a risk of some sort. One such situation occurs, for example, when a user is drilling an overhead hole while standing above ground level on a ladder. In order to interchange the positions of the drill bits when using the above-described tool of the prior art, the user must descend the ladder and then manually turn the turret after which he or she can re-ascend the ladder to continue using the drill with the new drill bit in place.

The illustrated examples relate to a tool having bit holders mounted at arcuately-spaced positions on a turret that is rotatable about an axis inclined to the shaft axis so that when one of the bit holders is brought to the position of use, the bit holder it replaces is moved to a storage position set back from the position of use so that it does not impede the usefulness of the tool. The illustrated examples relate to a tool, for example, a pistol-grip power drill designed to be used with one hand and having chucks providing the bit holders for the tool bits.

Throughout the ensuing description the expressions “bit(s)”, “tool bit(s)” and “drill bit(s)” are intended to refer to any suitable drill or tool device that can be mounted in the bit holders of the tool of the illustrated examples and which can be used to perform various actions including, but not limited to, drilling, grinding, countersinking, enlarging, threading and screwing.

The illustrated examples provide a hand-held tool including a plurality of turret-mounted bit holders that can each be selectively interchanged to a position of use without requiring the use of both hands of an operator.

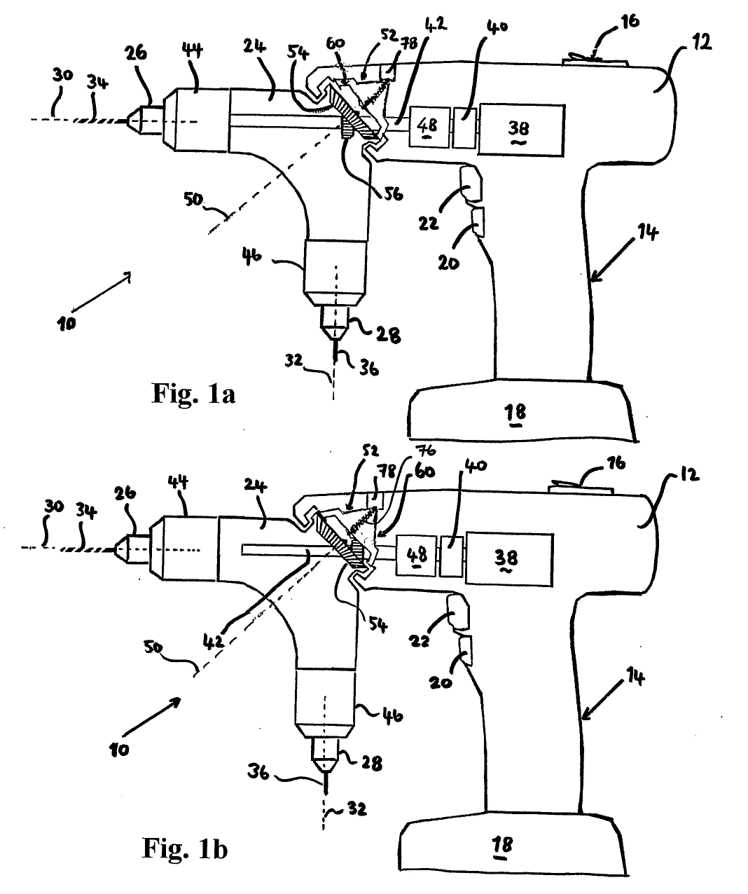

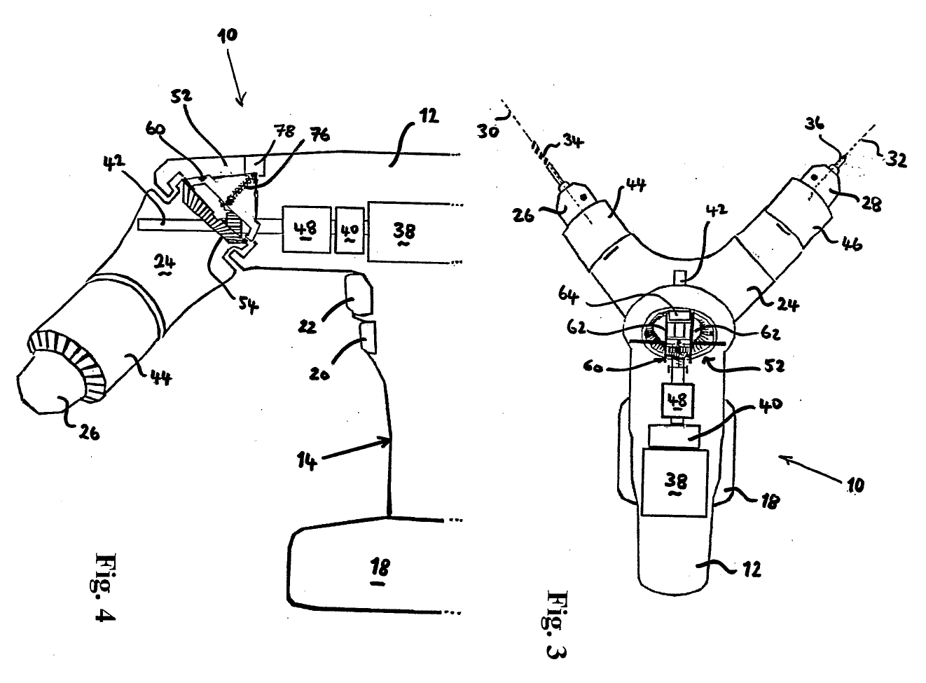

In FIGS. 1 to 5f illustrates an example hand-held tool 10 of any suitable form, for example an electric drill as shown. Although the examples illustrate an electric drill the hand-held tool 10 may be embodied in many other forms and, therefore, is not limited to the specific examples as shown

FIGS. 1a & 1b illustrate the example hand-held tool 10 as a drill having an example body casing 12 with an example pistol grip portion 14 that a user (not shown) of the hand-held tool 10 (hereinafter simply referred to as “drill 10”) may hold comfortably with a hand. An example speed-control slide or a switch 16 may allow the speed of the drill 10 to be altered to suit different materials (not shown) to be drilled. The pistol grip portion 14 may have an enlarged base 18 to enable a rechargeable battery (not shown) to be fitted to the drill 10 to power the same. Two trigger switches 20,22 respectively may include a power ON/OFF switch (20) for the drill 10 and an example chuck-changing switch (22).

Although not illustrated in the figures, the example drill 10 may be powered by an AC mains supply or by a pneumatic or hydro-static drill device instead of utilizing a rechargeable battery as the power supply means as shown in the drawings. Therefore, the description is not limited to the specific examples described.

In the illustrated examples, the forward end of the body casing 12 carries an example rotatable turret 24 on which at least two example drill chuck 26, 28 are mounted. However, more than two chucks may be provided, if necessary, and, therefore, the description is not limited to the specific examples provided. Chucks 26,28 may have respective axes of rotation 30,32 that enable different tool bits 34,36, for example drill bits as shown, to be mounted in respective chucks 26,28 as shown. The body casing 12 may contain an electric motor 38 powered by the battery of the tool 10 by way of the ON/OFF switch 20, and an example reduction gear box 40 controlled by the speed-control switch 16 that transmits the drive of the motor 38 to an example drive shaft 42.

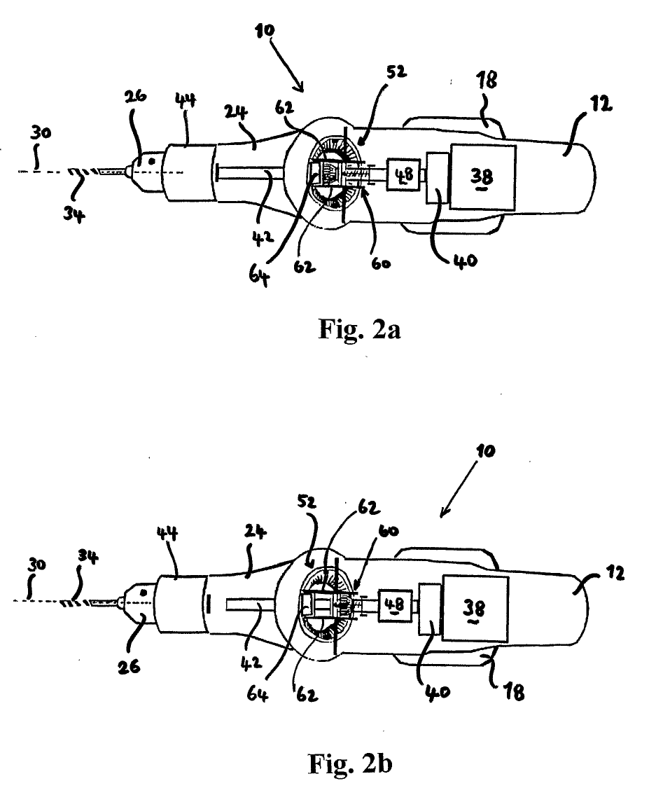

As is shown in FIGS. 1a & 1b (and in plan view in FIGS. 2a & 2b) the drive shaft 42 may be axially reciprocal between two, axially-spaced positions by the chuck-changing switch 22 when chucks 26,28 are to be interchanged with one another at the forward end of the drill 10. Chucks 26,28 may be mounted on respective example socket connectors 44,46 that are rotatably mounted on the turret 24 so that their axes 30,32 are set at a suitable angle to one another, for example, substantially 90° as shown. Each of the socket connectors 44,46 may have a central rear socket (not shown) that may have a flared entry that guides a complementary shaped plug formation (not shown) formed on the forward end of the drive shaft 42 into the central rear sockets during movement of the drive shaft 42 to a first or engaged position (see for example FIGS. 1a & 2a). In this way (referring to the position of chuck 26 in FIG. 1a) the plug formation of the drive shaft 42 may be mated with the central rear socket of the socket connector 44 such that the rotational drive from the drive shaft 42 is transferred to the socket connector 44 and the chuck 26 at the forward end of the drill 10.

The drive shaft 42 may be resiliently biased by a spring or any other suitable means (not shown) towards the engaged position (FIGS. 1a & 2a) at which the plug formation engages with the central rear socket (not shown)of the socket connector 44 at the forward end of the drill 10. Operation of an example solenoid 48 moves the drive shaft 42 against the spring bias, to a second or disengaged position (see for example FIGS. 1b & 2b) that is axially spaced from the engaged position (of FIGS. 1a & 2a) and at which the plug formation at the forward end of the drive shaft 42 is withdrawn from the central rear socket (not shown) of the socket connector 44. Instead of utilizing a spring or similar means (not shown) to return the drive shaft 42 to the engaged position, the drill 10 may simply utilize a dual-action solenoid or similar means (not shown) to perform the same action and, therefore, the description is not limited to the specific examples provided.

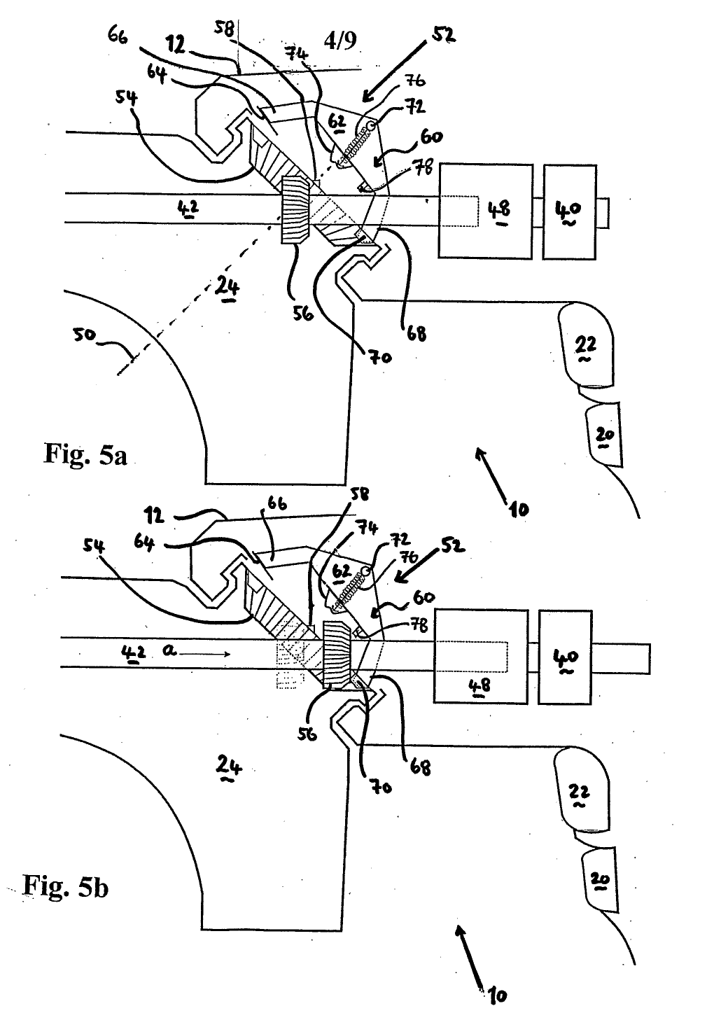

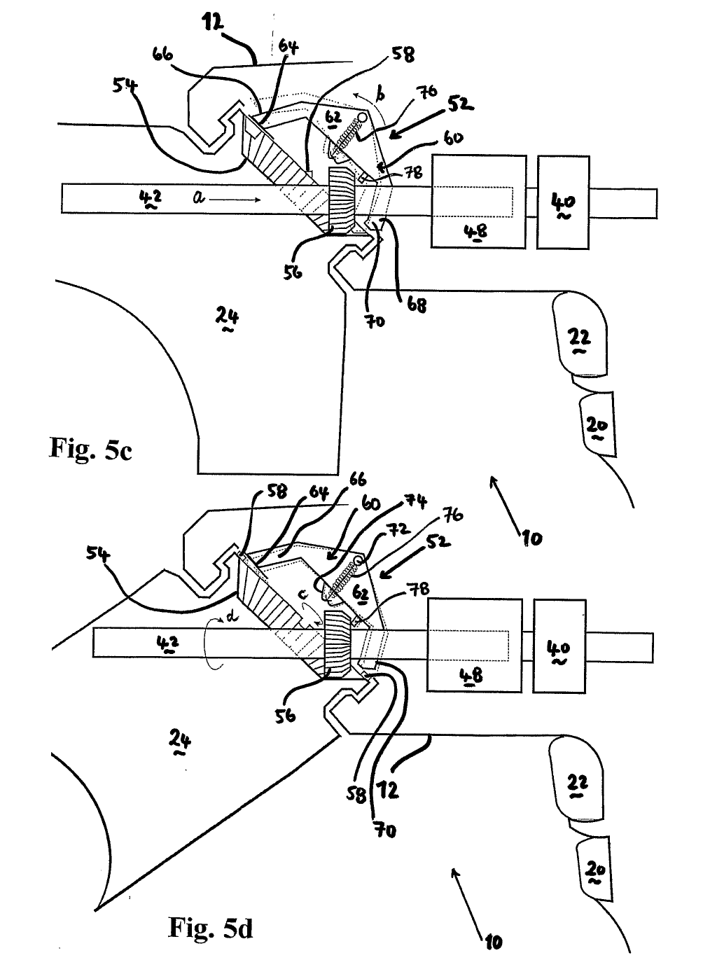

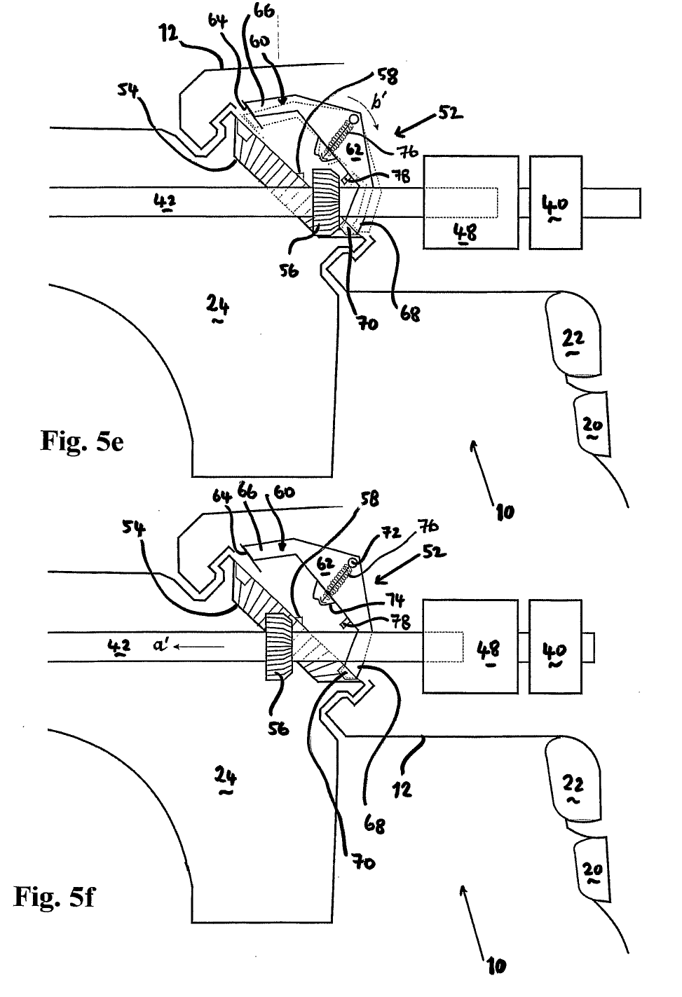

The turret 24 may be mounted so that the turret 24 may be rotated about an axis 50 after the plug formation of the drive shaft 42 has been withdrawn from the socket connector 44 to the disengaged position (of FIGS. 1b & 2b). The axis 50 may be set at substantially an angle of 45° to the axis of the drive shaft 42 as shown in the drawings, but may be set at any suitable angle. Both axes may lie in the same plane as the longitudinal axis of the pistol grip portion 14. Rotation of the turret 24 is may be carried out to interchange the positions of chucks 26,28 by the operation of an example mechanism 52 shown in more detail in FIGS. 5a to 5f and described in more detail below.

FIG. 5a illustrates that the mechanism 52 of the drill 10 may include a toothed circular rack or a ring gear 54 arranged concentrically with respect to the rotational axis 50 of the turret 24, and may be coupled to or integral with the turret 24. A bevel gear or a pinion 56 may be coupled to the drive-shaft 42 and may be brought into mesh with the ring gear 54 by movement of the drive shaft 42 from the engaged position to the disengaged position in the direction of arrow a (see FIG. 5b) by the activation of the solenoid 48 in response to the selective operation of the chuck-changing switch 22. The upper peripheral edge or surface of the ring gear 54 carries two chevron-shaped blocks 58 arranged on diametrically opposite sides of the axis 50 as shown in FIG. 5a, and which each may include a pair of opposed ramp surfaces. The blocks 58 may be each positioned to cooperate with an example rocker 60.

The rocker 60 may include two parallel arms 62 (see plan views of FIGS. 2a, 2b & 3) having a strip or a bridge 64 joining one pair of ends 66. The bridge 64 may include a smooth underside surface that may abut against the upper peripheral edge of the ring gear 54 during operation of the mechanism 52. The opposed ramp surfaces of the blocks 58 may act against the bridge 64 of the rocker 60 as the ring gear 54 is rotated by the pinion 56 (see FIG. 5d). The remaining pair of ends 68 of the parallel arms 62 may terminate in respective detents 70 that engage between the teeth of the ring gear 54 when the rocker 60 is in the rest position (illustrated in solid lines in FIGS. 5a, 5b, 5e & 5f. The rocker 60 may be mounted on a pin 72 that may be mounted in bushings (not shown) that allow the pin 72 to rotate about the pin's axis. The underside of the pin 72 carries between the parallel arms 62 a segment 74 having the underside toothed as shown, and which may include a cup (not shown) arranged on or integral with the upper surface. The cup (not shown) receives the lower end of a coiled compression spring 76 that may be retained within the interior of a straight tube (not shown). As shown in FIGS. 1a to 4, the upper end of the rocker 60 may be attached to the body casing 12, by the pin 72, at an example thrust block 78.

The rocker 60 may be biased to the rest position of the rocker 60 by the segment 74 and the spring 76. The toothed underside surface of the segment 74 includes an over-centering device that in cooperation with the spring 76 maintains the rocker 60 in two stationary positions, one being the rest position (FIGS. 5a, 5b, 5e & 5f) and the other being a tripped position (FIGS. 5c & 5d). The rocker 60 shifts to the tripped position in the direction of arrow b (see FIG. 5c) when the pinion 56 engages with and pushes a tripping block 78 affixed to, or integral with, the underside surface of the parallel arms 62, as the pinion 56 is drawn into mesh with the ring gear 54 in the direction of arrow a. The rocker 60 may return to the rest position (see FIGS. 5d & 5e) in the direction of arrow b′ when the underside surface of the bridge 64 is engaged with and urged upwards by the chevron-shaped blocks 58, as the ring gear 54 is rotated in the direction of arrow c by the pinion 56 (which rotates with drive shaft 42 in the direction of arrow d.

Use of the example drill 10 and the selective automated rotation of the turret 24 in response to activation of the chuck-changing switch 22 will now be described in more detail with reference to FIGS. 5a to 5f.

When drive shaft 42 is engaged with the socket connector 44 (as shown in FIGS. 1a & 2a—which corresponds to the position of the internal components of the drill 10 shown in FIG. 5a) overhead drilling (with the chuck 26 and corresponding the drill bit 34) may be carried out with a single hand of a user, by the selective operation of the ON/OFF trigger switch 20. The operation of the drill 10 may be carried out, if necessary, while the user is standing on a ladder that is being held with his/her other hand. The operation of the ON/OFF switch 20 may complete an electrical circuit (not shown) between the battery (not shown) and the motor 38 that includes an output drive that is transferred by way of the gearbox 40 to the drive shaft 42. That drive shaft 42 may rotate at a speed determined by the depth of the squeeze applied to the ON/OFF switch 20.

The positions of the chucks 26,28 (and the corresponding drill bits 34,36) may be selectively interchanged when necessary by first releasing the ON/OFF switch 20. When the ON/OFF switch 20 is released, the electric circuit to the motor 38 is broken, which stops rotation of the drive shaft 42. By then selectively depressing the chuck-changing switch 22, a user may interchange the positions of chucks 26,28 as required. Depressing the chuck-changing switch 22 energizes solenoid 48 that reciprocates the drive shaft 42 from the engaged position, in the direction of arrow a (FIGS. 5b & 5c), to the disengaged position (FIGS. 5c to 5e) at which time the plug formation (not shown) at the front end of the drive shaft 42 may be withdrawn from the socket connector 44. Movement of the drive shaft 42 to the disengaged position may cause the pinion 56 to engage and push the tripping block 78 of the rocker 60 that shifts the rocker 60 from the rest position to the tripped position in the direction of arrow b (FIG. 5c). The movement of the rocker 60 to the tripped position brings the underside surface of the bridge 64 into engagement with the upper peripheral edge of the ring gear 54. Simultaneously the rotation of the rocker 60 may lift the detents 70, at the ends 68, of the parallel arms 62 out of the slots between the teeth of the ring gear 54, while the pinion 56 meshes with the ring gear 54.

The user may then depress the ON/OFF trigger switch 20 with one finger while holding the chuck-changing switch 22 depressed with another finger. All of this may be done by the user with a single hand only so that his/her other hand is free, for example, to continue to support himself/herself on the ladder.

The action of depressing the ON/OFF switch 20 a second time may be to energize the motor 38 again but this time the motor's rotational drive is transmitted through the drive shaft 42 and the pinion 56 to the rotate turret 24 in the clockwise direction of arrow c (FIG. 5d). The position of the chucks 26,28 may be progressively interchanged (see the approximate mid-way position shown in FIGS. 3 & 4) until the turret 24 has rotated through approximating 180°, in the illustrated example to bring the socket connector 46 of the chuck 28 almost opposite the forward end of the drive shaft 42 so that the plug formation (not shown) is nearly aligned with the flared entry of the socket connector 46. The Chevron-shaped blocks 58 may be positioned on the ring gear 54 of the turret 24 so that when this occurs, the underside surface of the bridge 64 may be engaged by the ramp surfaces of the block 58 that forces the bridge 64 of the rocker 60 upwards that shifts the rocker 60 back to the rest position of the rocker 60 in the direction of arrow b′ (FIG. 5e). In the event that the detents 70, on the ends 68, of the parallel arms 62 are opposite (not meshed) respective teeth of the ring gear 54, the lifting of the bridge 64 may be accommodated by a small upward movement of the segment 74 against the resilient bias of the spring 76. The rotation of the turret 24 may not be obstructed and continues until the detents 70 are aligned between the teeth of the ring gear 54. The detents 70 then drop in-between the teeth to prevent further rotation of the turret 24.

At this time, the plug formation (not shown) at the forward end of the drive shaft 42 may be spaced opposite the flared entry to the socket connector 46. The chuck-changing switch 22 may then be released to de-energize the solenoid 48. The drive shaft 42 may then reciprocate back to the engaged position of the drive shaft 42 in the direction of arrow a′ (FIG. 5f) under the thrust of the spring bias acting on the drive shaft 42. During this movement, the plug formation is guided (by the flared entry if necessary) into the connector socket 46.

To interchange chucks 26,28 again, the user may release the ON/OFF switch 20, and press the chuck-changing switch 22 as before. The motor 38 is then de-energized and the solenoid 48 is activated to move the drive shaft 42 back into the disengaged position (in the direction of arrow a). By then operating the two switches 20,22 together, the turret 24 may be rotated through 180°, or any other suitable angle depending on the number of chucks, the chucks positioning, and the sequence as already described can be repeated.

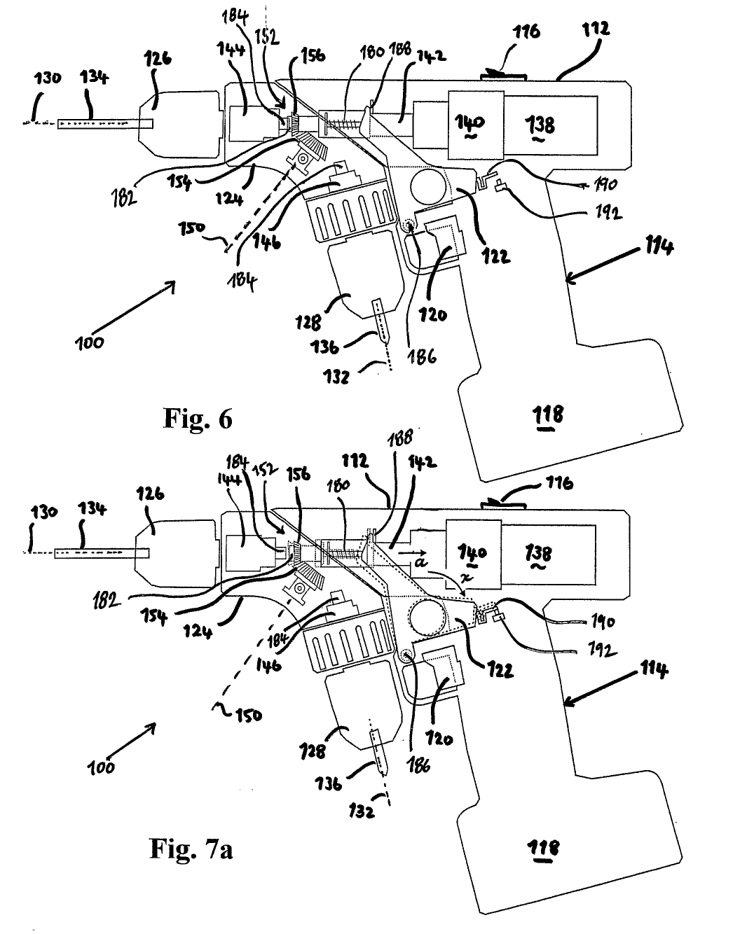

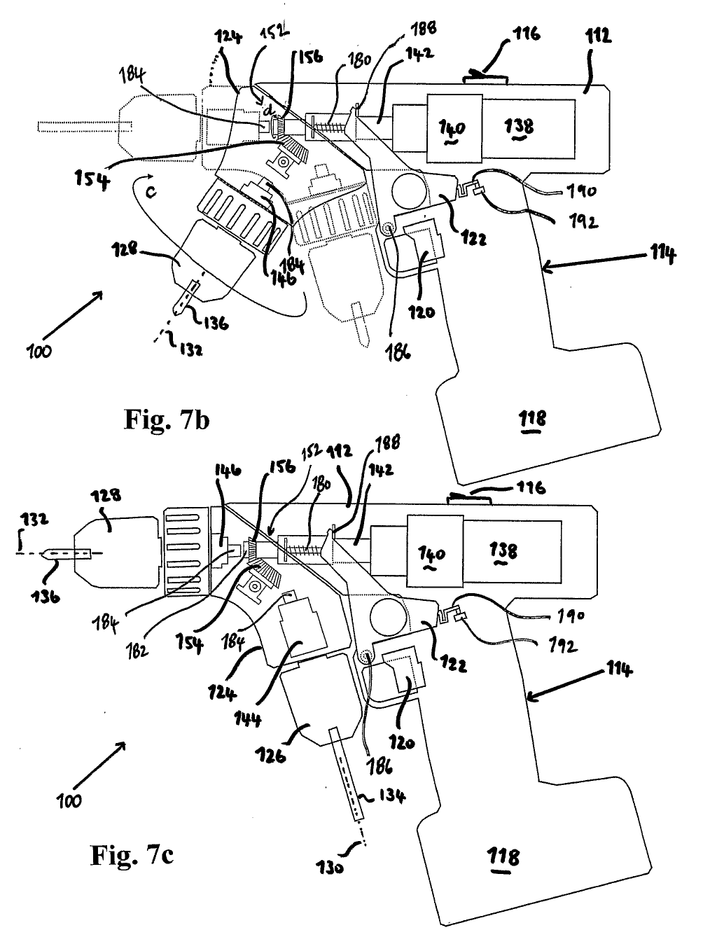

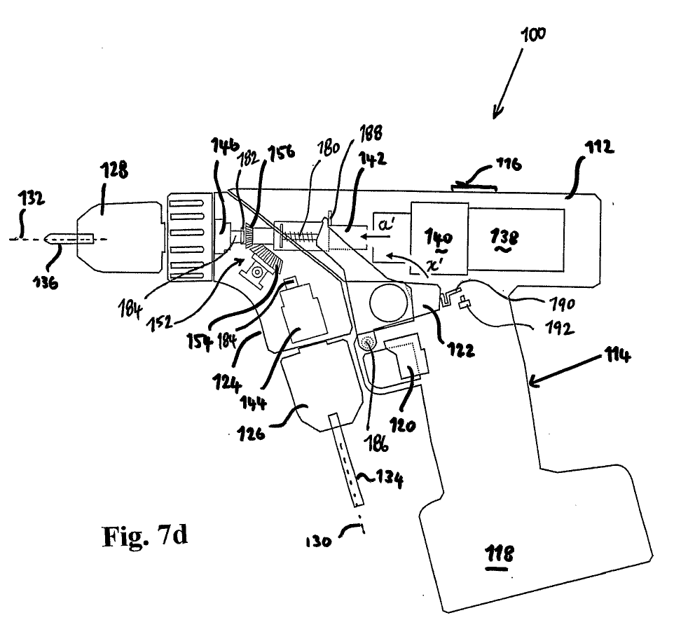

FIGS. 6 to 7d, illustrate an example hand-held tool 100 of any suitable form, for example an electric drill as shown, made in accordance with a second illustrated example. In FIGS. 6 to 7d like reference numerals correspond to like parts shown in FIGS. 5a to 5f.

The example tool 100 (hereinafter “drill 100”) of FIGS. 6 to 7d varies to that of the drill 10 of FIGS. 1a to 9d with respect to the way in which an example drive shaft 142 is moved between the engaged (FIGS. 6 & 7d) and the disengaged (FIGS. 7a to 7c) positions, and also with respect to the components of an example mechanism 152. These major differences will now be discussed.

FIG. 6, like in the case of the drill 10 of FIGS. 1a to 5f, illustrates that the drive shaft 142 of the drill 100 may be resiliently biased by an example spring 180 (or other suitable means) to the engaged position at which an example plug formation 182 engages with an example rear socket 184 of an example socket connector 144 at the forward end of the drill 100. Instead of utilizing a solenoid to move the drive shaft 142 to the disengaged position, the drill 100 of FIGS. 6 to 7d, may utilize a mechanical trigger mechanism that acts as an example chuck-changing switch 122 of the drill 100. The chuck-changing trigger 122 pivots in the direction of arrows x and x′ (see FIG. 7a & 7d) with respect to a pin 186. The chuck-changing trigger 122 assumes a rest position (see FIGS. 6 & 7d) when the drive shaft 142 is in the engaged position and moves to an activated position (see FIGS. 7a to 7c) when the drive shaft 142 is moved and assumes the disengaged position. In response to force applied to the chuck-changing trigger 122, and when the chuck-changing trigger 122 is moved to the activated position in the direction of arrow x, the drive shaft 142 is moved from the engaged position to the disengaged position in the direction of arrow a. An upper portion of the chuck-changing trigger 122 acts against an example protrusion 188 disposed on, or integral with, the drive shaft 142, that enables the chuck-changing trigger 122 to draw the drive shaft 142 into the disengaged position in the direction of arrow at when force is applied to the same. When the chuck-changing trigger 122 is released from the activated position, an example spring 180 may return the chuck-changing trigger 122 to the rest position in the direction or arrow x′ (FIG. 7d), while at tile same time the spring 180 returns tile drive shaft 142 to the engaged position in the direction of arrow a.

Positioned on the rear peripheral edge of the chuck-changing trigger 122 is an example extension 190 that may be arranged in such a manner that when the chuck-changing trigger 122 is forced to the activated position in the direction of arrow x, a trip switch 192 may be activated by extension 190. The activation of the trip switch 192 may complete an electric circuit (not shown) between the battery (not shown) and the motor 138 of the drill 100. When power is applied to the motor 138, the drive shaft 142 rotates in the direction of arrow d (see FIG. 7b) which causes the turret 124 to rotate in the direction of arrow c as a result of the pinion 156 being engaged with the mechanism 152 of the drill 100 in the disengaged position of the drive shaft 142.

Unlike in the case of the example drill 10 of FIGS. 1a to 5f, the mechanism 152 of the example drill 100 may be a gear 154 disposed within the turret 124 that is engaged and driven by the pinion 156 when the drive shaft 142 is rotated in the direction of the arrow d (FIG. 7b) while in the disengaged position. Instead of the drill 100 of FIGS. 6 to 7d having the mechanism 152 utilizing a rocker arrangement (60) which correctly positions chucks (26,28) at the chucks respective positions of use, as in the case of drill 10 of FIGS. 1a to 5f, the drill 100 may utilize sensors or switches (not shown) that detect when the turret 124 is correctly aligned with the chucks 126,128 so that the drive shaft 142 can move back to the engaged position in the direction of arrow a′ when the chuck-changing trigger 122 is released.

Unlike in the case of the drill 10 of FIGS. 1a to 5e, the chuck-changing trigger 122 of the drill 100 may enable the turret 124 to be rotated by the action of a single finger, that is, the chuck-changing trigger 122 may provide a dual-action arrangement that simultaneously disengages the drive shaft 142 and rotates the turret 124 to interchange chucks 126,128. This same action may be achieved by the operation of the ON/OFF switch 20 and the chuck-changing switch 22 of the drill 10 of FIGS. 1a to 5f.

In the illustrated examples, example drill 10 or 100, the turret 24 or 124 may be selectively and automatically rotated to interchange the chucks 26,126,28,128 by using only a single hand. Thus, the drill 10,100 of the illustrated examples include an automated chuck exchange system that allows for single handed operation and enables an operator to use a free hand to grasp, for example, a ladder while operating the drill.

While the examples have been described in connection with illustrations thereof, the tool is capable of further modification(s). The patent is intended to cover any variations, uses or adaptations of the description following in general, the principles of the description and including such departures from the description as come within known or customary practice within the art to which the description pertains and as may be applied to the essential features hereinbefore set forth.

The illustrated examples may be embodied in several forms without departing from the spirit of the essential characteristics of the description. The above described embodiments are not to limit the illustrated examples unless otherwise specified, but rather should be construed broadly within the spirit and scope of the disclosure as defined in the appended claims. Various modifications and equivalent arrangements are intended to be included within the spirit and scope of the illustrated examples and appended claims. Therefore, the illustrated examples are to be understood to be illustrative of the many ways in which the principles of the illustrated examples may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

As discussed above, the illustrated examples provide an example tool including a plurality of example bit holders interchangeable with one another at a position of use in front of the tool. The bit holders may be mounted at arcuately-spaced positions on an example turret rotatable around an axis set at an angle to an axis of rotation of an example drive shaft that may be reciprocal between a first and a second axially-spaced locations at which, respectively, the drive shaft is engaged and disengaged from a bit holder at the position of use. The positioning of the drive shaft at the second location may establish a drive connection between the drive shaft and the turret so that subsequent operation of the drive shaft rotates the turret to interchange the positions of the bit holders at the position of use. The drive shaft is adapted to return to first location and restore the drive connection with a new bit holder at the position of use after the turret has been rotated.

The example turret may have an axis of rotation set at substantially an angle of 45° to the drive shaft axis, and may be equipped with two bit holders. This arrangement may be particularly useful, for example, when the tool has a pistol grip, as it enables a bit holder not at the position of use to occupy a storage position at which it lies in front of the pistol grip.

The example tool further includes at least two triggers to control the operation of the tool. A first trigger may be selectively operable to establish rotation of the drive shaft, and a second trigger may be selectively operable to reciprocate the drive shaft between the first and the second axially-spaced locations. The triggers may be arranged, for example, on a pistol grip portion of the tool.

In some examples the drive shaft carries a pinion that may be located at a non-functioning station when the drive shaft is in the first location, and which moves into meshing engagement with a ring gear disposed on or integral with the turret when the drive shaft is in the second location. Subsequent rotation of the drive shaft may rotate the turret and, therefore, interchanges the positions of the bit holders at the position of use.

In one example, use of the second trigger activates a solenoid that moves the drive shaft to the second location. Rotation of the turret may be achieved by selectively activating the first trigger while the drive shaft is in the second location.

In an alternative example, the drive shaft carries a pinion that is located at a non-functioning station when the drive shaft is in the first location that moves into meshing engagement with an example gear located within the turret when the drive shaft is in the second location. Subsequent rotation of the drive shaft rotates the turret and, therefore, interchanges the positions of the bit holders at the position of use.

In such an example, the second trigger may be a mechanism that mechanically moves the drive shaft to the second location as force is applied to the trigger. When the second trigger has moved the drive shaft to the second location a sensor or switch may be activated that establishes rotation of the drive shaft and, therefore, rotates the turret.

The tool may be a battery powered drill and the bit holders may be drill chucks.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A tool including comprising:
a drive shaft having an axis of rotation;
a plurality of bit holders interchangeable with one another at a position of use, the bit holders are mounted at arcuately-spaced positions on a turret rotatable around an axis set at an angle to the axis of rotation of the drive shaft which is reciprocal between first and second axially-spaced locations at which, respectively, the drive shaft is engaged and disengaged from the bit holder at the position of use, wherein the positioning of the drive shaft at the second location establishes a drive connection between the drive shaft and the turret so that subsequent operation of the drive shaft rotates the turret to interchange the positions of the bit holders at the position of use, and wherein the drive shaft is adapted to return to the first location and restore the drive connection with a new bit holder at the position of use after the turret has been rotated.

2. The tool as defined in claim 1, wherein the turret has an axis of rotation set at substantially 45° to the drive shaft axis, and is equipped with two bit holders.

3. The tool as defined in claim 1, further comprising at least two triggers to control the operation of the tool.

4. The tool as defined in claim 3, wherein a first trigger is selectively operable to establish rotation of the drive shaft, and a second trigger is selectively operable to reciprocate the drive shaft between the first and second axially-spaced locations.

5. The tool as defined in claim 3, wherein the triggers are arranged on a pistol grip portion of the tool.

6. The tool as defined in claim 1, wherein a pinion is coupled to the drive shaft that is located at a non-functioning station when the drive shaft is in the first location, and which moves into meshing engagement with a gear disposed on or integral with the turret when the drive shaft is in the second location, wherein subsequent rotation of the drive shaft rotates the turret and, therefore, interchanges the positions of the bit holders at the position of use.

7. The tool as defined in claim 6, wherein the gear is a ring gear.

8. The tool as defined in claim 4, wherein use of the second trigger activates a solenoid that moves the drive shaft to the second location.

9. The tool as defined claimed in claim 4, wherein rotation of the turret is achieved by selectively activating the first trigger while the drive shaft is in the second location.

10. The tool as defined in claim 1, wherein the drive shaft carries a pinion which is located at a non-functioning station when the drive shaft is in the first location that moves into meshing engagement with a gear position within the turret when the drive shaft is in the second location, wherein subsequent rotation of the drive shaft rotates the turret and, therefore, interchanges the positions of the bit holders at the position of use.

11. The tool as defined in claim 3, wherein the second trigger is a mechanism that mechanically moves the drive shaft to the second location as force is applied to the second trigger.

12. The tool as defined in claim 11, wherein when the second trigger has moved the drive shaft to the second location a sensor is activated that establishes rotation of the drive shaft and, therefore, rotates the turret.

13. The tool as defined in claim 11, wherein when the second trigger has moved the drive shaft to the second location a switch is activated that establishes rotation of the drive shaft and, therefore, rotates the turret.

14. The tool as defined in claim 1, wherein the tool is a battery powered drill and the bit holders are drill chucks.

15. (canceled)

16. (canceled)
